(19) United States
(12) Patent Application Publication
(10) Pub. No.: US 2008/0046593 A1
(43) Pub. Date: Feb. 21, 2008

(54) Information providing service control system

(75) Inventors: Tatsuhiro Ando, Kawasaki (JP); Keiji Mizuma, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/657,086

(22) Filed: Jan. 24, 2007

(30) Foreign Application Priority Data
Jul. 28, 2006 (JP) JP2006-206887

(51) Int. Cl. G06F 15/16

(52) U.S. Cl. 709/245

(57) ABSTRACT

In order to deliver information from an information transmission terminal to multiple user terminals in a specific area regardless of a type of an access network, a system includes managing location information of areas that the plurality of user terminals are located in association with multiple URIs; sending, in response to a first inquiry, the plurality of URIs associated with the plurality of user terminals in the specific area, the first inquiry being created based on the location information of the specific area entered from the information transmission terminal; managing the plurality of URIs of the user terminals in association with multiple IP addresses; and sending, in response to a second inquiry from the information transmission terminal, the plurality of IP addresses associated with the plurality of user terminals in the specific area, the second inquiry being created based on the URIs sent in response.

### BACKGROUND OF THE INVENTION

The present invention relates to an information providing service control system which integrates access networks of different types (e.g. 3G mobile, WLAN and WiMAX) with an IP (Internet Protocol) network so that an information transmission (originating) terminal can deliver information to multiple user terminals in a specific area using an IP address regardless of the type of the access networks.

DDDS (Dynamic Delegation Discovery System) is an abstract algorithm concerning application of a dynamically obtained character string conversion rule to a character string specific to each piece of application software. An application example of DDDS is ENUM-DNS (Domain Name System) servers. In information transmission (call control) technology using an ENUM-DNS server, “E.164 phone number”, which is globally unique phone number compliant with ITU-T (ITU-Telecommunication Standardization Sector) serves as the retrieval key in retrieving the identifier URI (SIP-URI: Session Initiation Protocol-Uniform Resource Identifier) of a communication terminal at the other end of communication (also referred to as information receiver terminal or user terminal), and the URI in turn serves as the retrieval key in retrieving an IP address. The IP address is used by an information transmission terminal to establish a connection with the communication terminal at the other end of communication, and information is thus provided.

However, the conventional information transmission technology is limited to communications with, or information providing to, a specific communication terminal whose phone number is known in advance, and has such problems as being incapable of providing information to multiple unspecified communication terminals with location information (area information) as key information.

The problems of the conventional information transmission technology mentioned above are schematically shown in FIG. 1. Referring to FIG. 1, the conventional information transmission technology has the following problems:

(1) Problem 1: It is not possible for an information sender to make a telemarketing sales call to multiple users (information receiver terminals) located in a specific area. This is because making a phone call with an E.164 phone number “+81-xx-xxx-xxxx” as key information is not possible unless the URI and IP address of an information receiver terminal are registered in advance in the ENUM-DNS server and a normal DNS server.

(2) Problem 2: The ENUM-DNS server can send in response only one URI to an information sender.

(3) Problem 3: When a mobile IP phone terminal is an information receiver terminal and moves from one location to another causing its IP address to change, identifying the IP address from its URI and, accordingly, making a phone call to the information receiver terminal, are not possible.

(4) Problem 4: Information receiver terminals whose wireless access networks differ from one another cannot be managed with the use of physical location information. Therefore, it is not possible to call the information receiver terminals with location information as key information.

(5) Problem 5: These problems make it impossible to make a telemarketing sales call to multiple information receiver terminals that are located in a specific area and use various different wireless access networks (in other words, make it impossible to deliver information to such information receiver terminals).

A location information-based information transmission technique in prior art documents listed below (Patent Documents 1 to 4) maintains and searches a location information database and delivers information to, or commences communications with, multiple user terminals under the following conditions:

(1) Limited to specific wireless access technologies such as wireless LAN (Local Area Network).

(2) Limited to specific application software such as PoC (Push-to-Talk over Cellular).

(3) Limited to specific devices (information delivery servers).

The following are related arts to the present invention.

### [Patent document 1] Japanese Patent Laid-Open Publication No. 2005-312045

### [Patent document 2] Japanese Patent Laid-Open Publication No. 2003-179606

### [Patent document 3] Japanese Patent Laid-Open Publication No. 2003-99449

### [Patent document 4] Japanese Patent Laid-Open Publication No. 2004-88440

### SUMMARY OF THE INVENTION

An object of this invention is to provide a technique with which information can be delivered to multiple users in a specific area irrespective of the type of access network.

To solve the above-mentioned problem, the present invention provides an information providing service control system which integrates access networks of different types with an IP core network so that information can be delivered from an information transmission terminal to multiple user terminals in a specific area using an IP address regardless of the type of access network, including: a first management module for managing location information of the area where the plurality of user terminals are located in association with multiple URIs; a first resolution module for sending, in response to a first inquiry, the URIs that are associated with the user terminals in the specific area, the first inquiry being created from location information of the specific area which is entered from the information transmission terminal; a second management module for managing the URIs of the user terminals in association with multiple IP addresses; and a second resolution module for sending, in response to a second inquiry from the information transmission terminal, the IP addresses that are associated with the user terminals in the specific area, the second inquiry being created from the URIs sent in response.

The information providing service control system further includes an analyzing module for discriminating whether a received message is a first message or a second message and determining where to transfer the message, the first message being for having the first resolution module resolve the URIs based on the location information, the second message being for having the second resolution module resolve the IP addresses based on the URIs.

In the information providing service control system, the first management module, the first resolution module, the second management module, and the second resolution module are placed in at least one DNS server. In the information providing service control system, the first management module and the first resolution module are placed in a first DNS server, the second management module and the second resolution module are placed in a second DNS server, and the analyzing module is placed in a third DNS server.

In the information providing service control system, the first inquiry is a DDDS query and the second inquiry is a DNS query. The first message and the second message are DNS messages. The access networks of different types include multiple types of access network selected from the group consisting of wireless access networks, specifically, wireless LANs, mobile phone networks, and WiMAX networks, and wired networks. In other words, the present invention is not limited to wireless access networks and wireless terminals, and are applicable to wired terminals such as desktop personal computer terminals and wired access networks containing wired terminals.

In the information providing service control system, the location information of an area where multiple user terminals are located and the location information of a specific area entered from the information transmission terminal are mapped onto an E.164 phone number system, and the first resolution module resolves the URI through an ENUM procedure. These two sets of location information each contain an identifier for identifying an area and an identifier that indicates the type of the access network.

The present invention makes area-based information delivery utilizing IP technology possible regardless of the type of access network, and information can be delivered uniformly, by multi-cast or the like, to user terminals whose access network types differ from one another if the user terminals are in the same area.

The present invention uses DNS and DHCP, which are general IP mechanisms, to accomplish the function, and therefore can readily be applied to existing application software (message sending software and the like).

Other objects, features and advantages of the present invention will become clear through the following specification (embodiment) when read in conjunction with the drawings and Scope of Claims.

### BRIEF DESCRIPTION OF THE DRAWINGS

FIG. 1 is a diagram illustrating problems of prior art;

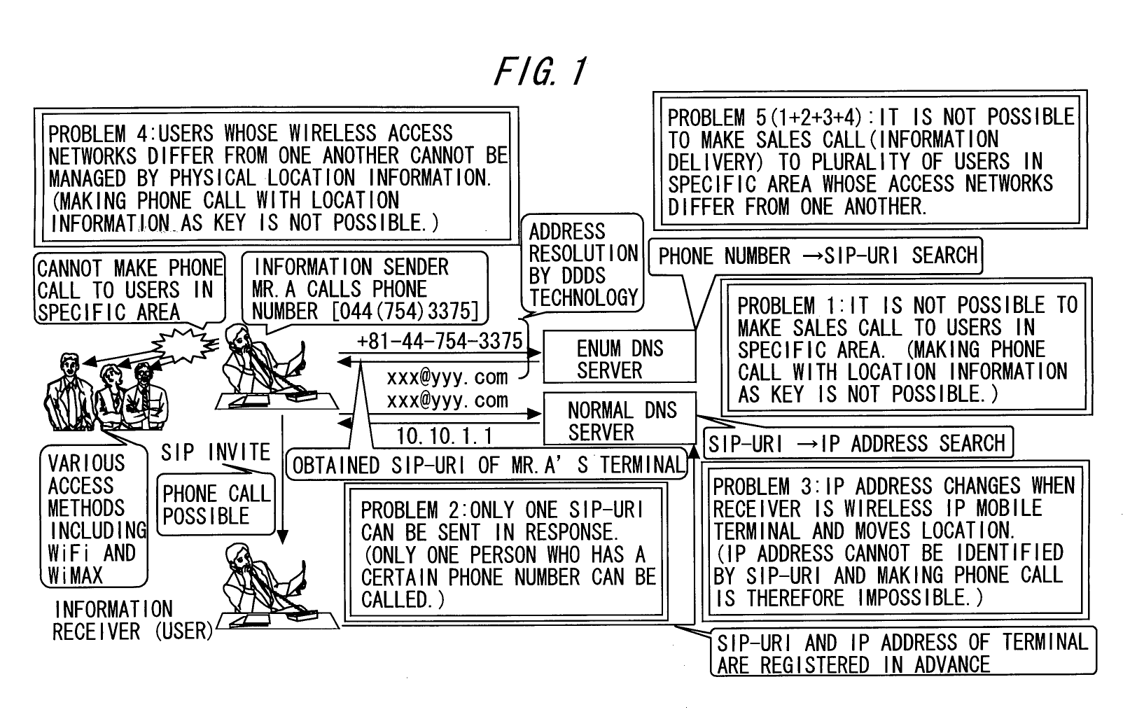

FIG. 2 is a block diagram showing a system configuration according to an embodiment of the present invention;

FIG. 3 is a diagram showing a terminal location registration sequence;

FIG. 4 is a diagram showing a sequence of URI resolution through DDDS and information delivery;

FIG. 5 is a block diagram showing a configuration example of a user terminal;

FIG. 6A is a flow chart illustrating activation processing in the user terminal;

FIG. 6B is a flow chart illustrating area code management processing in the user terminal;

FIG. 6C is a flow chart illustrating handover processing in the user terminal;

FIG. 6D is a flow chart illustrating data deletion processing in an LDNS server;

FIG. 7 is a block diagram showing a configuration example of an information transmission terminal;

FIG. 8 is a block diagram showing a configuration example of a DHCP server;

FIG. 9 is a diagram showing an example of extending a DHCP packet format;

FIG. 10 is a block diagram showing a configuration example of a DNS server;

FIG. 11 is a block diagram showing a configuration example of a local DNS server;

FIG. 12 is a block diagram showing a configuration example of the LDNS server;

FIG. 13 is a diagram showing an example of extending a DNS update message;

FIG. 14 is a diagram showing an example of extending a DDDS message;

FIG. 15 is a diagram illustrating a configuration example of location information (area code); and

FIG. 16 is a diagram showing an example of extending a DNS message.

### DETAILED DESCRIPTION OF THE PREFERRED EMBODIMENTS

A more detailed description will be given below on the present invention with reference to the accompanying drawings. The drawings show preferred embodiments of the present invention. However, the present invention can be carried out in various other modes, and should not be misunderstood as being limited to the embodiments described herein. Rather than limiting the present invention, these embodiments are provided to make the disclosure of this specification thorough and complete, and descriptive to convey the scope of the present invention well to those skilled in the art.

[Configuration Example of Communication Network System]

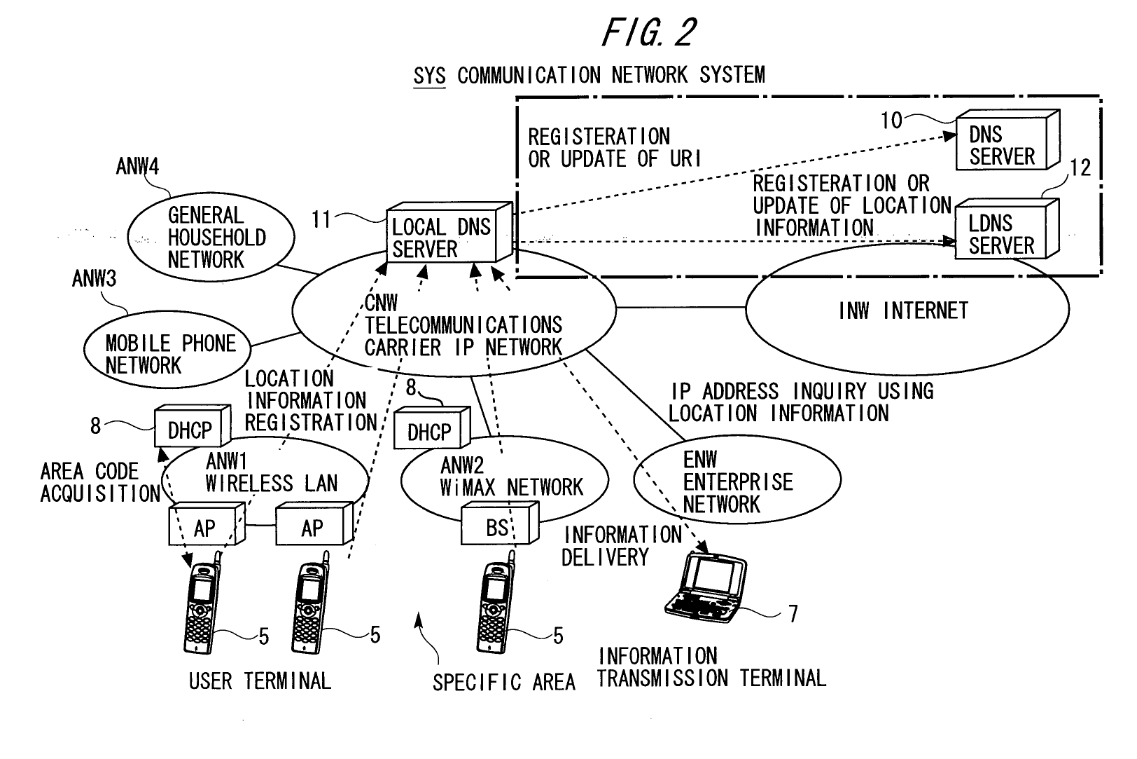

A reference is made to FIG. 2, which shows the configuration of a communication network system according to an embodiment of the present invention. The communication network system SYS is a system for integrating wireless access networks and wired access networks of different types with a telecommunications carrier IP network CNW, which is an all-IP core network, and constitutes an information providing service control system that uses a DNS (Domain Name System) server 10 to manage location information of a user terminal 5 (area information) through DDDS (Dynamic Delegation Discovery System), so information can be delivered to multiple user terminals 5 located in a specific area regardless of the type of access network.

The telecommunications carrier IP network CNW is connected to wireless access networks of different types including a wireless LAN (WLAN: Wireless Local Area Network) ANW1, a WiMAX (Worldwide Interoperability for Microwave Access) network ANW2, and a mobile phone network ANW3. The telecommunications carrier IP network CNW is also connected to a general household network ANW4, which is a wired access network. Furthermore, the telecommunications carrier IP network CNW is connected to an enterprise network ENW. The telecommunications carrier IP network CNW includes geographically (locally) varying IP networks that are built specific to areas such as the Kanto region/Kansai region (the eastern/western parts of Japan) or prefectures, but is spread nationwide to logically constitute the Internet INW together with a provider network.

The wireless LAN ANW1, as a public wireless LAN spot, has not-shown components including a wireless LAN controller and a wired LAN, and allows the user terminals 5 in a wireless zone (service area) it provides to access via access points AP. The user terminals 5 that can access the wireless LAN ANW1 are mobile terminals such as mobile IP phone terminals and PDAs (Personal Digital Assistants).

The WiMAX network ANW2 has not shown components including a base station controller, and allows the user terminals 5 in a wireless zone it provides to access via base stations BS. The user terminals 5 that can access the WIMAX network ANW2 are mobile terminals such as mobile IP phone terminals and PDAs.

The mobile phone network ANW3 has not shown components including base stations, a base station controller, and a telephone switchboard, and allows the user terminals 5 in a wireless zone it provides to access via the base stations. The user terminals 5 that can access the mobile phone network ANW3 are mobile terminals such as mobile IP phone terminals and PHSs (Personal Handyphone Systems).

The general household network ANW4, which is a landline telephone network, allows the user terminals 5 to access via a not-shown telephone switchboard. The user terminals that can access the general household network ANW4 are landline IP phone terminals and mobile IP phone terminals that are cordless handsets of landline phones.

The enterprise network ENW is built from Ethernet®, and allows an information transmission terminal 7 such as a personal computer to access.

In order to deliver information to multiple user terminals 5 in a specific area irrespective of the type of access network, the communication network system SYS is further composed of a DHCP (Dynamic Host Configuration Protocol) server 8, the DNS server 10, a local DNS server 11, and an LDNS (Location Domain Name System) server 12.

In this communication network system SYS, the DHCP server 8 is placed in the wireless LAN ANW1 and the WiMAX network ANW2 each, the local DNS server 11 is placed in the telecommunications carrier IP network CNW, and the DNS server 10 and the LDNS server 12 are placed in the Internet INW.

[Configuration Example of User Terminal]

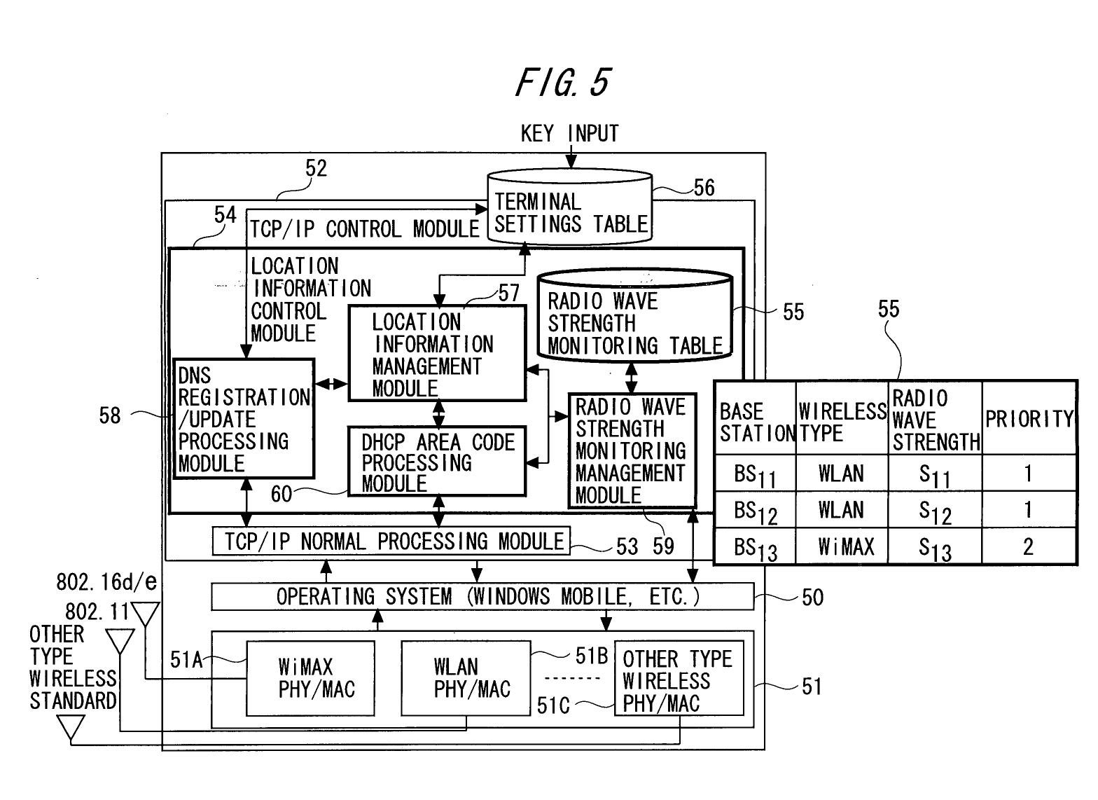

In the communication network system SYS shown in FIG. 2, the user terminal 5 employs a configuration shown in FIG. 5 in order to notify the LDNS server 12 of the current area code as location information (area information).

The user terminal 5 as a multi-wireless terminal has an OS (Operating System) 50, a PHY/MAC (Physical/Media Access Control) module 51 and a TCP/IP (Transmission Control Protocol/Internet Protocol) control module 52. The OS 50 is an OS of Windows® Mobile or the like.

The PHY/MAC module 51 is composed of a WiMAX PHY/MAC module 51A compliant with IEEE (Institute of Electrical and Electronics Engineers) 802.16d or 16e, a WLAN PHY/MAC module 51B compliant with IEEE 802.11, and an other type wireless PHY/MAC module 51C compliant with other type wireless standard. The WiMAX PHY/MAC module 51A controls the physical layer (the first layer) and MAC layer (the lower sublayer of the data link layer (the second layer)) of the WiMAX network ANW2. The WLAN PHY/MAC module 51B controls the physical layer and MAC layer of the wireless LAN ANW1. The other type wireless PHY/MAC module 51C controls the physical layer and MAC layer of the mobile phone network ANW3.

The TCP/IP control module 52 has a TCP/IP normal processing module 53 and a location information control module 54. The location information control module 54 is composed of a radio wave strength monitoring table 55, a terminal settings table 56, a location information management module 57, a DNS registration/update processing module 58, a radio wave strength monitoring management module 59, and a DHCP area code processing module 60.

The location information control module 54 in the TCP/IP control module 52 performs control related to location information separately from normal TCP/IP processing that is performed by the TCP/IP normal processing module 53. The radio wave strength monitoring table 55 is a database for managing the radio field intensities of base stations (wireless access devices) that are obtained by the radio wave strength monitoring management module 59 and then prioritized. The radio wave strength monitoring table 55 notifies the radio wave strength monitoring management module 59 of a base station of the highest priority as a marker device.

The terminal settings table 56 is a database for managing parameters that are entered and set in the user terminal 5 by a user in advance. The location information management module 57 obtains, manages, and creates an area code that is registered in the LDNS server 12 by the user terminal 5. The DNS registration/update processing module 58 controls registration/update of an area code in the LDNS server 12 by the user terminal 5.

The radio wave strength monitoring management module 59 monitors radio waves from the PHY/MAC module 51, and obtains the physical (MAC) address and radio field intensity of a base station. The DHCP area code processing module 60 obtains, from the radio wave strength monitoring management module 59, the MAC address of a base station that serves as a marker device, and communicates with the DHCP server 8 to obtain the area code of the user terminal 5.

[Configuration Example of Information Transmission Terminal]

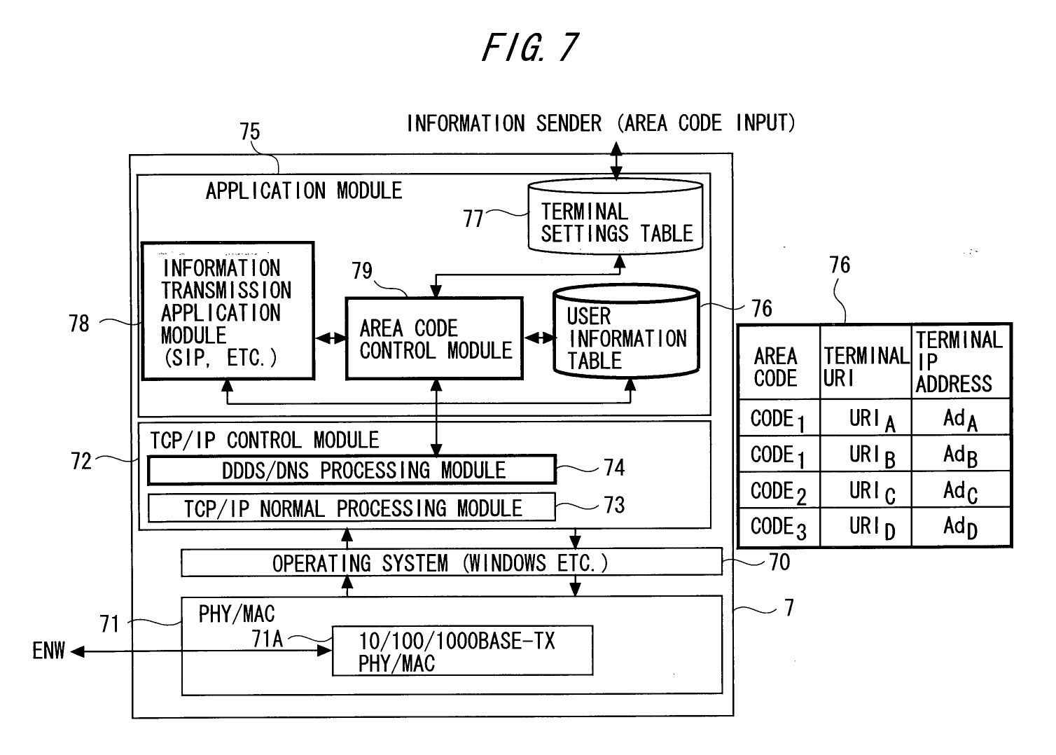

In the communication network system SYS shown in FIG. 2, the information transmission terminal 7 employs a configuration shown in FIG. 7 in order to ask the LDNS server 12 and the DNS server 10 for the URIs and IP addresses of multiple user terminal 5 located in a specific information delivery area and to deliver information to the user terminals 5. The user terminals 5 and the information transmission terminal 7 may be the same type of device.

The information transmission terminal 7 has an OS (Operating System) 70, a PHY/MAC module 71, a TCP/IP control module 72, and an application module 75. The OS 70 is an OS of Windows® or the like.

The PHY/MAC module 71 is composed of a 10/100/1000 Base-TX PHY/MAC module 71A. The 10/100/1000 Base-TX PHY/MAC module 71A exerts control on the physical layer and the MAC layer including control of transmission/reception of Ethernet® frames.

The TCP/IP control module 72 has a TCP/IP normal processing module 73 and a DDDS/DNS message processing module74. The TCP/IP normal processing module 73 performs normal TCP/IP processing. The DDDS/DNS message processing module 74 has a function of communicating with the DNS server 10 and the LDNS server 12 in order to obtain the URI (Uniform Resource Identifier) and IP address of the user terminal 5 to which information is to be delivered.

The application module 75 is composed of a user information table 76, a terminal settings table 77, an information transmission application module 78, and an area code control module 79.

The user information table 76 in the application module 75 is a database for storing the URI and IP address of the user terminal 5 that is associated with an area code obtained by the area code control module 79 from the DDDS/DNS message processing module 74. The terminal settings table 77 is a database for managing parameters that are entered and set in the information transmission terminal 7 by an information sender in advance.

The information transmission application module 78 is application software for transmitting information such as SIP (Session Initiation Protocol), and performs SIP or other call control procedures to establish a communication session with the user terminal 5.

The area code control module 79 cooperates with the DDDS/DNS message processing module 74 in storing, in the user information table 76, obtained URIs and IP addresses of multiple user terminals 5 in association with an area code entered by the information sender. The area code control module 79 also notifies the information transmission application module 78 of the IP addresses of multiple user terminals 5.

[Configuration Example of DHCP Server]

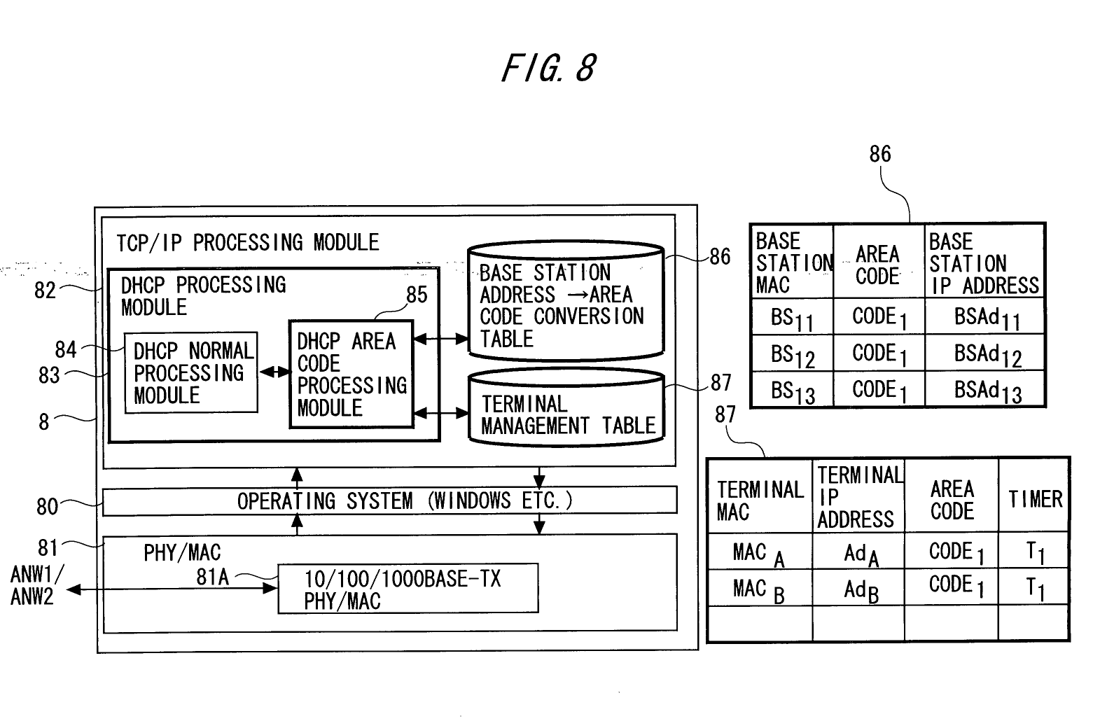

In the communication network system SYS shown in FIG. 2, the DHCP server 8 employs a configuration shown in FIG. 8 in order to notify the user terminal 5 of the area code of an area where the user terminal 5 is located.

The DHCP server 8 has an OS (Operating System) 80, a PHY/MAC module 81, and a TCP/IP processing module 82. The OS 80 is an OS of Windows® or the like.

The PHY/MAC module 81 is composed of a 10/100/1000 Base-TX PHY/MAC module 81A. The 10/100/1000 Base-TX PHY/MAC module 81A exerts control on the physical layer and the MAC layer including control of transmission/reception of Ethernet® frames.

The TCP/IP processing module 82 has a DHCP processing module 83, which includes a DHCP normal processing module 84 and a DHCP area code processing module 85, a conversion table 86, and a terminal management table 87.

The TCP/IP processing module 82 performs normal processing and extended processing related to TCP/IP. The DHCP processing module 83 performs normal processing and extended processing that relate to only DHCP out of TCP/IP. The DHCP normal processing module 84 performs normal processing related to DHCP. The DHCP area code processing module 85 distributes an area code to the user terminal 5 using DHCP.

The conversion table 86 is a database for managing the area code and IP address of a base station (an access point AP or a base station BS) in association with the MAC address of the base station. The terminal management table 87 is a database for managing an IP address and an area code that are assigned (allocated) to the user terminal 5.

The DHCP server 8 also has a conversion table 86 for conversion between the MAC address of a base station of a wireless access network as an access network, or the MAC address of a default gateway of a wired access network, and location information of the base station or the default gateway. The DHCP server 8 employs this configuration to send, along with an allocated IP address, location information of a base station of a wireless access network to be accessed or location information of a default gateway of a wired access network as location information of an area where the user terminal 5 is located, in response to an inquiry that is made by the user terminal 5 when the user terminal 5 receives radio waves from the base station, or an ARP response from the default gateway, and that contains the obtained MAC address of the base station of the wireless access network or of the default gateway.

[Configuration Example of DNS Server]

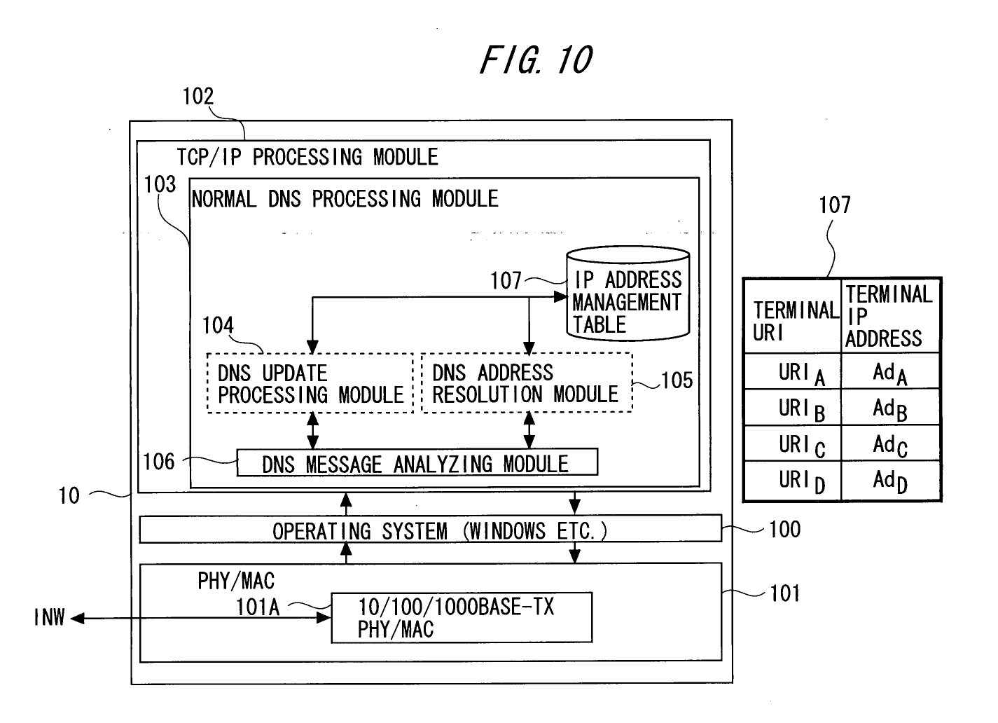

In the communication network system SYS shown in FIG. 2, the DNS server 10 employs a configuration shown in FIG. 10 in order to manage the relation between the URI and IP address of the user terminal 5.

The DNS server 10 has an OS (Operating System) 100, a PHY/MAC module 101, and a TCP/IP processing module 102. The OS 100 is an OS of Windows® or the like.

The PHY/MAC module 101 is composed of a 10/100/1000 Base-TX PHY/MAC module 101A. The 10/100/1000 Base-TX PHY/MAC module 101A exerts control on the physical layer and the MAC layer including control of transmission/reception of Ethernet® frames.

The TCP/IP processing module 102 has a normal DNS processing module 103, which performs various types of normal processing that are to be controlled by the DNS server 10. The normal DNS processing module 103 is composed of a DNS update processing module 104, a DNS address resolution module 105, a DNS message analyzing module 106, and an IP address management table 107.

The DNS update processing module 104 in the normal DNS processing module 103 updates an IP address that is associated with the URI of the user terminal 5. The DNS resolution module 105 receives an inquiry (DDDS query) from the information transmission terminal 7 via the local DNS server 11 and sends, in response, an IP address that is associated with the URI of the user terminal 5.

The DNS message analyzing module 106 analyzes a DNS message received from the local DNS server 11, and determines whether the message is about update of the IP address of the user terminal 5 or resolution (inquiry) of the IP address of the user terminal 5. The IP address management table 107 is for managing an IP address that is associated with the URI of the user terminal 5.

[Configuration Example of Local DNS Server]

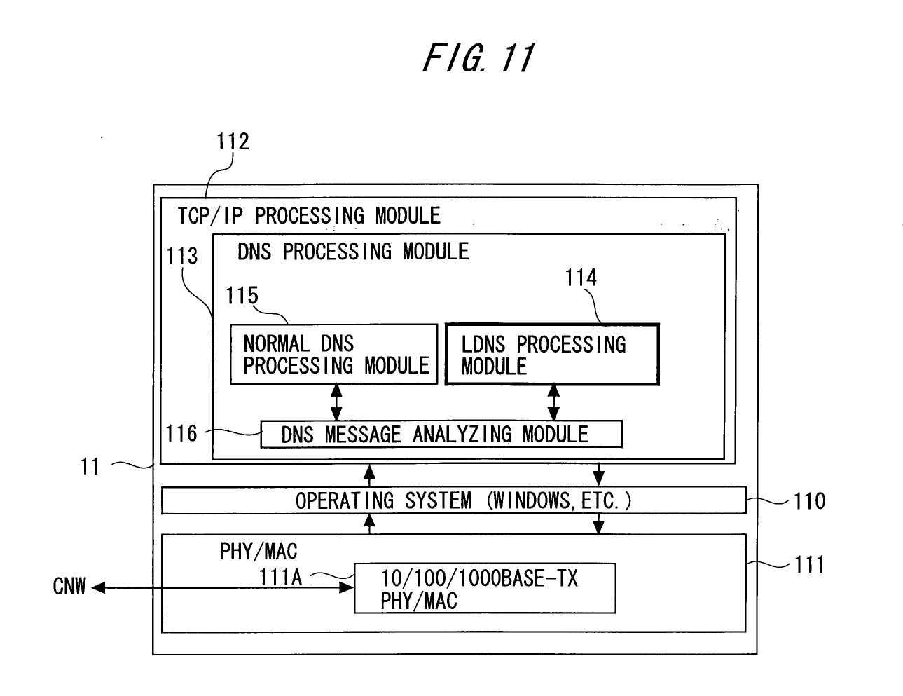

In the communication network system SYS shown in FIG. 2, the local DNS server 11 employs a configuration shown in FIG. 11 in order to allocate messages between the LDNS server 12, which manages area codes, and the DNS server 10, which performs normal processing.

The local DNS server 11 has an OS (Operating System) 110, a PHY/MAC module 111, and a TCP/IP processing module 112. The OS 110 is an OS of Windows® or the like.

The PHY/MAC module 111 is composed of a 10/100/1000 Base-TX PHY/MAC module 11A. The 10/100/1000 Base-TX PHY/MAC module 111A exerts control on the physical layer and the MAC layer including control of transmission/reception of Ethernet® frames.

The TCP/IP processing module 112 has a DNS processing module 113, which analyzes a DNS message received from the user terminal 5 to determine whether the message is about update of the IP address of the user terminal 5 or resolution (inquiry) of the IP address of the user terminal 5. The DNS processing module 113 is composed of an LDNS processing module 114, a normal DNS processing module 115, and a DNS message analyzing module 116.

The LDNS processing module 114 in the DNS processing module 113 communicates, as a proxy for the user terminal 5, with the LDNS server 12 on the Internet INW, and asks for a URI that is associated with an area code. The LDNS processing module 114 also updates a URI.

The normal DNS processing module115 performs various types of normal processing that are to be controlled by the DNS server 10. Specifically, the normal DNS processing module 115 communicates, as a proxy for the user terminal 5, with the DNS server 10 on the Internet INW and asks for an IP address that is associated with a URI. The normal DNS processing module 115 also updates an IP addresses.

The DNS message analyzing module 116 analyzes a DNS message that the user terminal 5 receives from the DNS server 10, and determines whether the message is about update or resolution (inquiry) of the IP address of the user terminal 5.

[Configuration Example of LDNS Server]

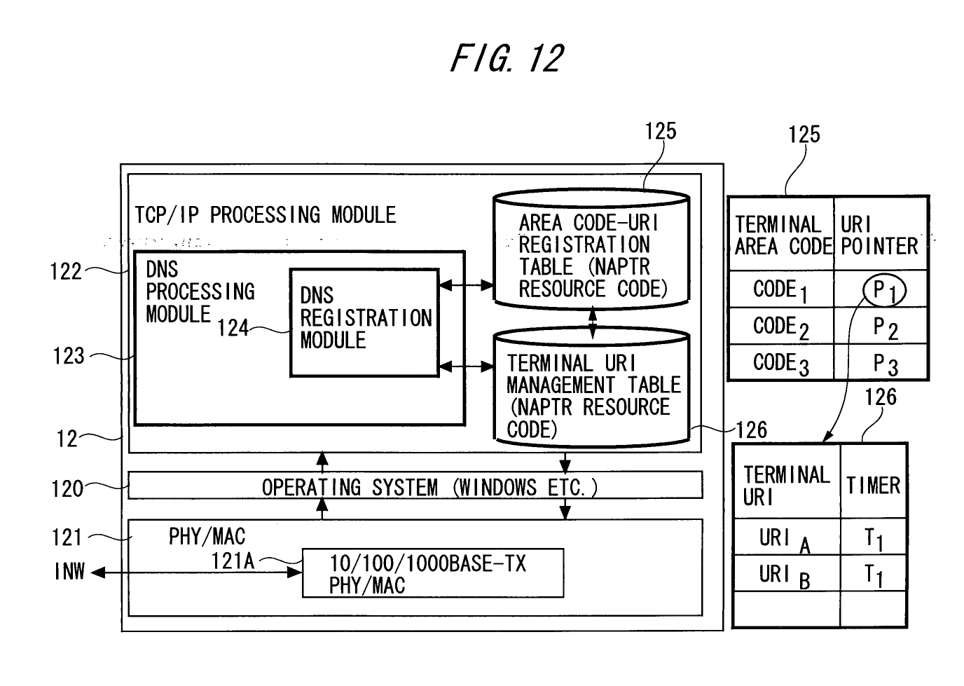

In the communication network system SYS shown in FIG. 2, the LDNS server 12 employs a configuration shown in FIG. 12 in order to manage the area code of the user terminal 5.

The LDNS server 12 has an OS (Operating System) 120, a PHY/MAC module 121, and a TCP/IP processing module 122. The OS 120 is an OS of Windows® or the like.

The PHY/MAC module 121 is composed of a 10/100 Base-TX PHY/MAC module 121A. The 10/100 Base-TX PHY/MAC module 121A exerts control on the physical layer and the MAC layer including control of transmission/reception of Ethernet® frames.

The TCP/IP processing module 122 performs normal processing and extended processing related to TCP/IP. The TCP/IP processing module 122 has a DNS processing module 123, which has a DNS registration module 124, an area code-URI registration table 125, and a terminal URI management table 126.

The DNS processing module 123 processes DNS messages received from the local DNS server 11. The DNS registration module 124 has a function of processing a DNS message received from the local DNS server 11 to obtain area code-URI association information and registers the obtained information in the area code-URI registration table 125. The DNS registration module 124 also performs timer monitoring for keeping stored data it manages up to date.

The area code-URI registration table 125 is a database that receives an area code and sends, in response, a pointer (URI pointer) which is used in referring to another database, specifically, the terminal URI management table 126, in order to manage the URIs of multiple user terminals 5 associated with an area code.

The terminal URI management table 126 is a database for managing the URIs of multiple user terminals 5 that are associated with a specific area code. The terminal URI management table 126 engages in database cooperation with the area code-URI registration table 125 through pointers.

[Operation Example of Communication Network System]

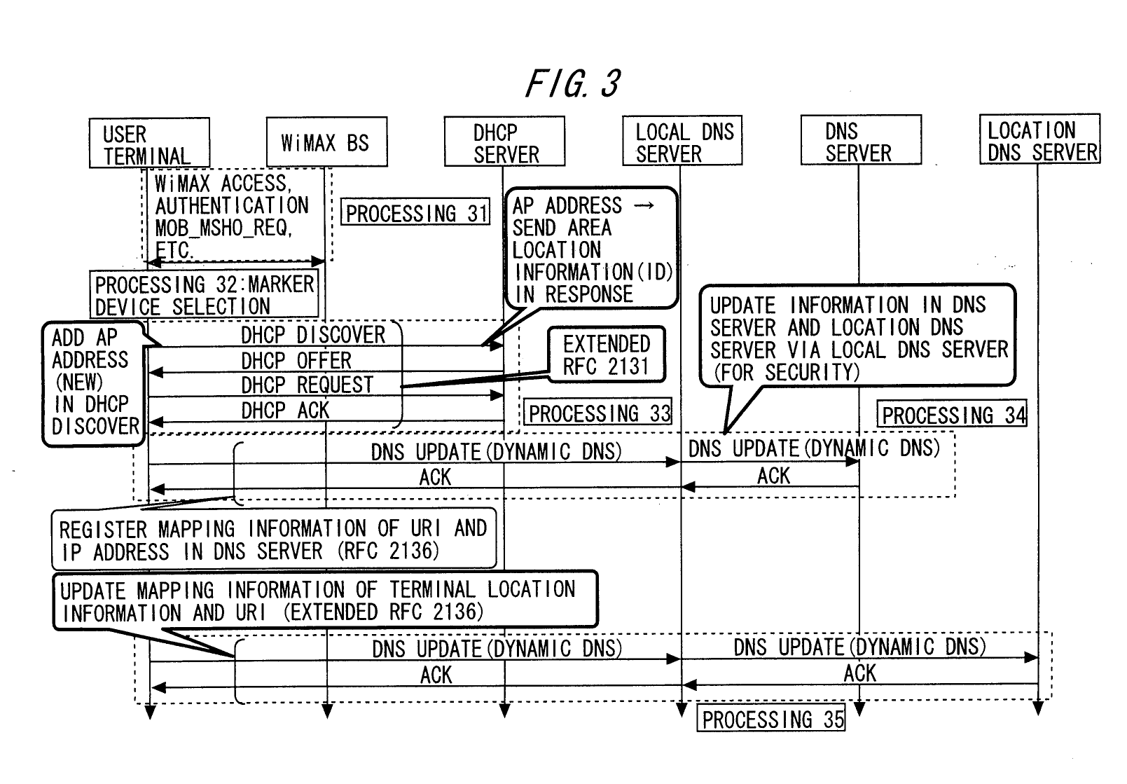

Described next with reference to FIGS. 3 to 16 is an operation example of the communication network system SYS according to an embodiment of the present invention that is shown in FIG. 2. In the following detailed description of the operation example, the intervention of the telecommunications carrier IP network CNW and other networks will not be mentioned unless discrimination is necessary.

In this communication network system SYS, a DDDS protocol for resolving a URI between the DNS server 10 and the user terminal 5 is extended such that multiple URIs (e.g., SIP-URI) and multiple IP addresses are resolved from location information.

For dynamic update of location information when the user terminal 5 moves from one location to another, the location information and the registered IP address are automatically updated by the DDNS (Dynamic Domain Name System) function as the user terminal 5 enters a specific area.

In future application to an all-IP network system, type differences among wireless access networks such as the wireless LAN ANW1 and the WiMAX network ANW2 are absorbed by using the same location information for the user terminal 5 that are in the same area regardless of the type of access network. Therefore, when the user terminal 5 is connected to a network, the DHCP server 8 sends in response area information as location information to the user terminal 5 based on the L2 address (MAC address) of the base station BS of the wireless access network or the L2 address of the access point AP. The user terminal 5 uses the received area information to register location information in the DNS server 10.

[Operation A: Terminal Location Registration Procedure]

In the communication network system SYS shown in FIG. 2, when the user terminal 5 accesses a network, an area code (area ID) as location information is manually entered in the user terminal 5 by the user or obtained from the DHCP server 8 to register the location in the LDSN server 12 via the local DNS server 11. The sequence of this terminal location registration procedure is shown in FIG. 3.

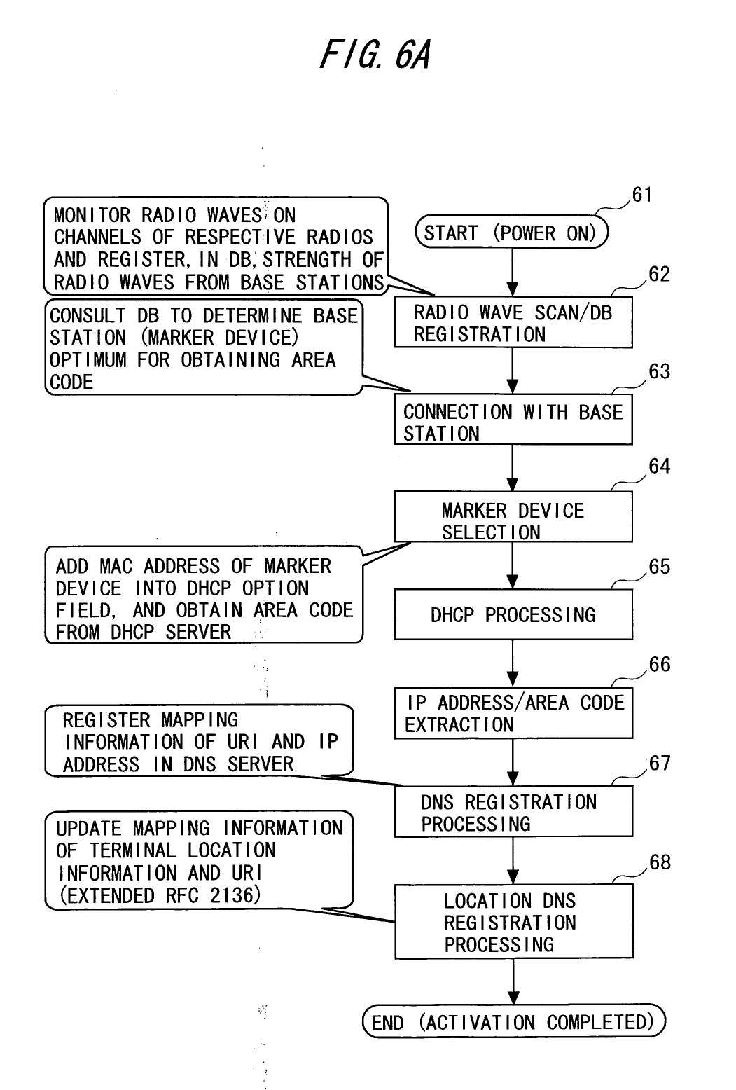

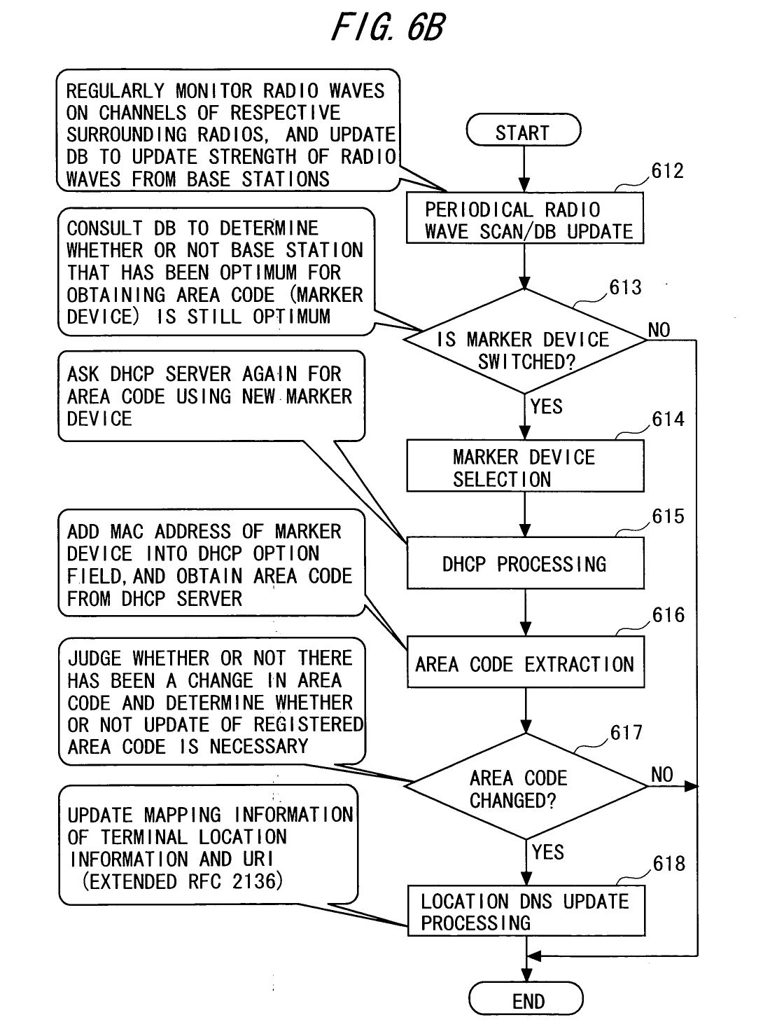

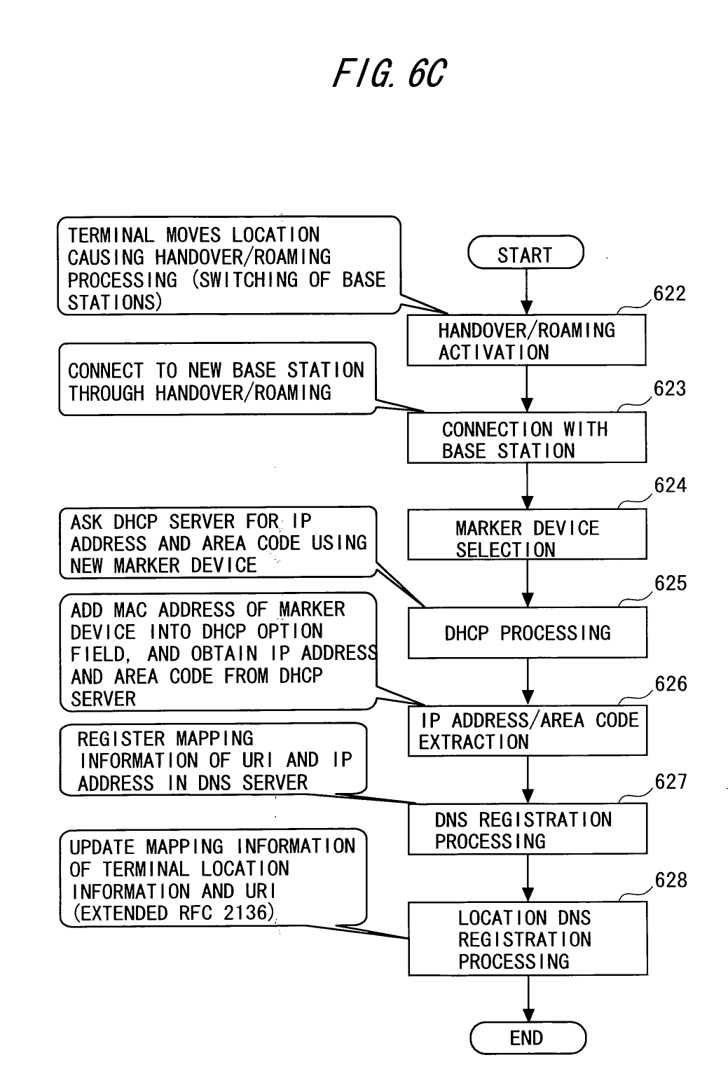

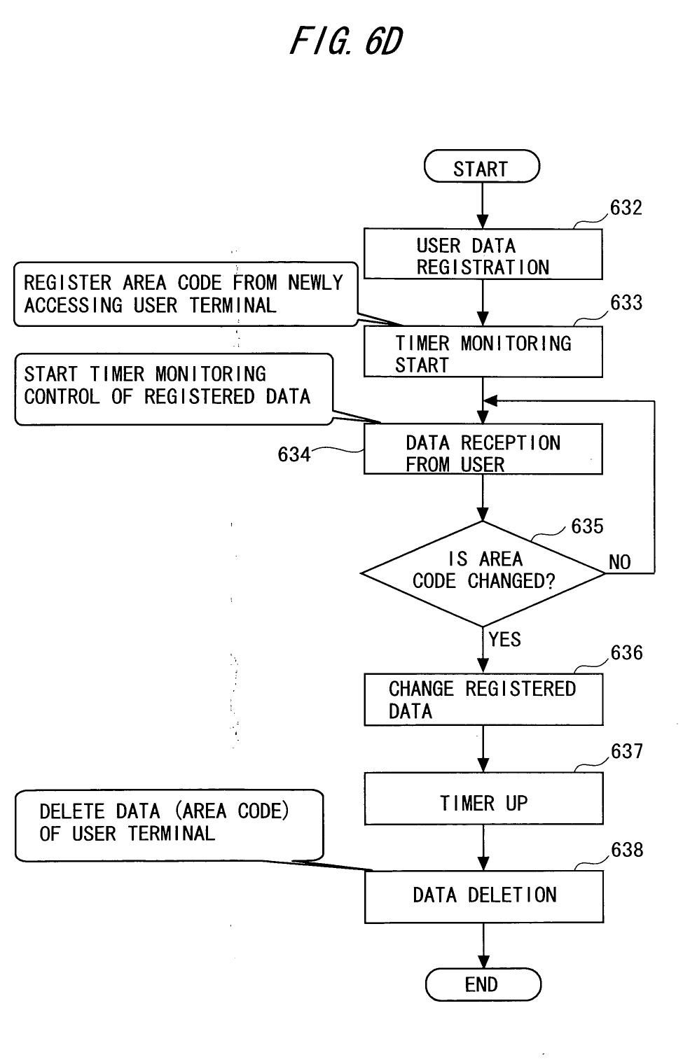

A flow chart of an activation operation in the user terminal is shown in FIG. 6A (Processing Steps 61 to 68). The terminal location registration processing and the user terminal activation processing are outlined as follows:

(1) The user terminal 5 is powered on and activated (Processing Step 61).

(2) In order to register the radio wave strengths of base stations (62) in the database (DB), the user terminal (multi-wireless terminal) 5 which can use multiple types of wireless access technology monitors radio waves of all wireless access networks and all channels.

(3) In order to determine which one is a marker device (63, 64), a base station of a wireless access network that serves as the reference for identifying location information is determined as a marker device instead of a wireless access network that is actually accessed. For instance, the wireless LAN ANW1 or other wireless access networks that have a narrow access area and accordingly allow fine identification of location information are preferred to the WiMAX network ANW2. The radio wave strengths of radio waves received from base stations are stored in the radio wave strength monitoring table 55, and a marker device (wireless access device) to serve as the reference for area code identification is determined from the radio wave strength and from the priority set in advance in accordance with the type of wireless access network. There may be multiple marker devices.

(4) DHCP Processing (65): The hardware address (MAC address) of the marker device is inserted in an extension field of an inquiry made to obtain an IP address from the DHCP server 8. The DHCP server 8 searches for an area code with the MAC address of the marker device as the key, and sends the area code to the user terminal 5 in response to the inquiry.

(5) Area Code Extraction (66): The user terminal 5 stores, in the terminal settings table 56, the area code obtained from the DHCP server 8 in response to the inquiry. If the association between a base station and an area code is stored in the terminal settings table 56 on the assumption that the user terminal 5 moves frequently, the number of times the inquiry is made to the DHCP server 8 is reduced.

(6) DNS Server Registration Processing (67): Mapping information of the URI and IP address of the user terminal 5 is registered in the DNS server 10. The URI and the IP address need to be registered (updated) through DDNS as often as suitable on the assumption that the user terminal 5 moves to new locations where the user terminal 5 uses various IP addresses to access.

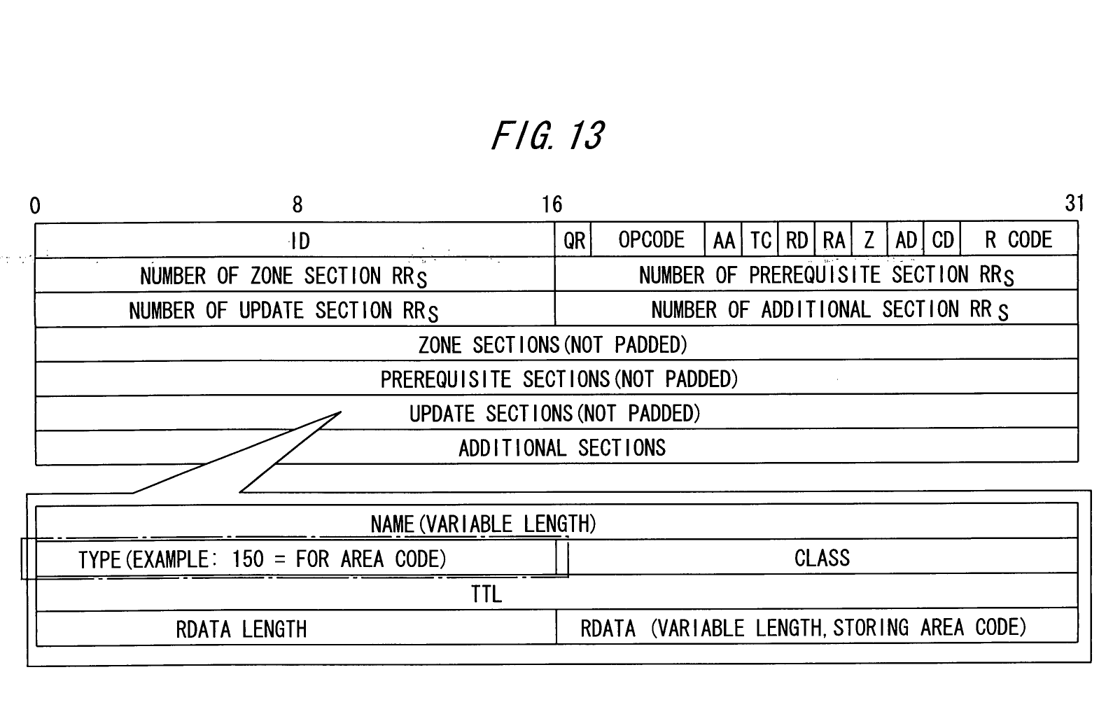

(7) LDNS Registration Processing (68): The obtained area code is used to register in the LDNS server 12. The DNS server 10 and the LDNS server 12 are accessed via the local DNS server 11, which is owned by a telecommunications carrier. FIG. 13 shows an example of extending a DNS update message for use in processing of registering in the LDNS server 12.

Details of each of the processing will be described next.

Processing 1: Presetting of Parameters (Processing Step 61 in FIG. 6A)

In the case where the DHCP server 8 is yet to obtain location information because it is not long after the user terminal 5, whose configuration is detailed in FIG. 5, is activated (powered on), or from other reasons, the user precedes the DHCP server 8 and manually enters location information of an area where the user terminal 5 is located. The user directly enters an area code as location information through a key input module (omitted from the drawing) of the user terminal 5, and the area code is set in the location information management module 57 of the location information control module 54. In this case, the step of obtaining an area code in Processings 3 and 4, which will be described later, is unnecessary.

In this embodiment, an area code serving as location information is expressed with the use of an existing, globally unique phone number system (E.164). Details are as follows:

(1) An unused country number (for example, +83) is used as a key number (identifier code) that identifies the data as location information, and the remaining 9-digit phone number is systemized into location information.

(2) An existing system covering city code and local number is utilized since this embodiment values compatibility with existing communication network systems and area partitioning.

(3) The remaining digits (subscriber number) are all “0” or customized to fit the area. For instance, the number can be further specified by employing wireless access network type number (access network identifier).

Advantages of expressing location information with the use of an existing phone number system include compatibility with the existing phone number system, the ease of imagining location information, and simpler mounting resulting from high compatibility with conventional methods in retrieving a URI (SIP-URI) from a phone number.

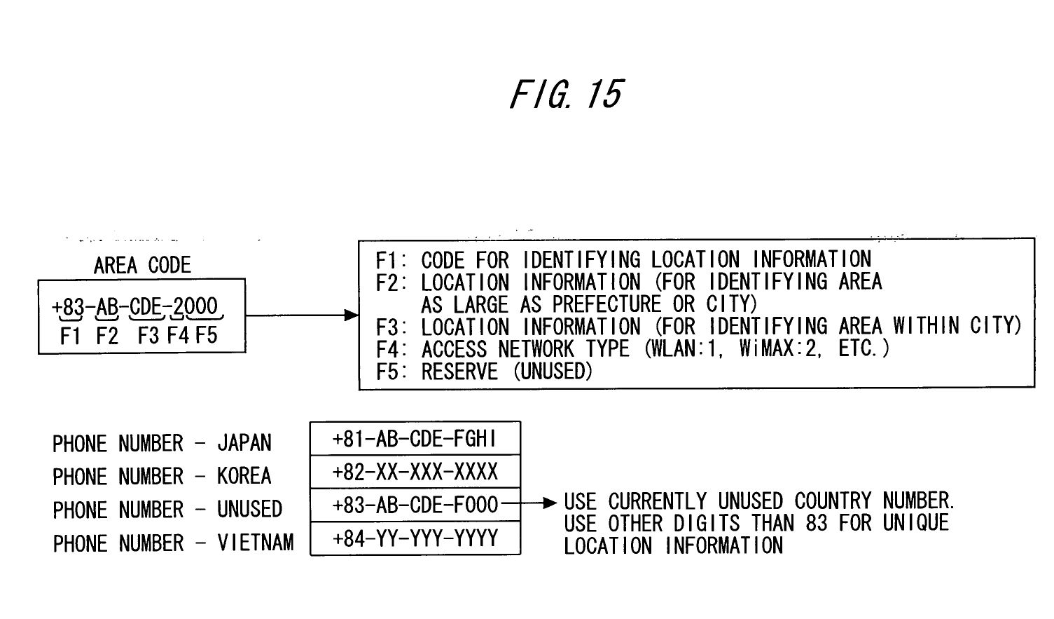

FIG. 15 shows a specific example of an area code as location information. In an area code “+83-ab-cde-2000” shown in FIG. 15, an identification field F1 holds a code for identifying location information, F2 holds identification information of an area as large as a prefecture or a city, F3 holds identification information of an area within a city, F4 holds access network type information (access network identifier), and F5 is a reserved (unused) field.

Processing 2: Wireless/Wired Network Connection (see Processing 31 of FIG. 3)

To access a network, the user terminal 5 normally connects to a wireless access device, such as the access point AP of the wireless LAN ANW1 or the base station BS of the WiMAX network ANW2, through which an authentication server (omitted from the drawing) performs user authentication. The user terminal 5 is allowed to connect to the network in question only when verified through this user authentication.

Processing 3: Marker Device Selection (see Processing 32 of FIG. 32) (Processing Step 61 in FIG. 6A)

In the case where the parameter presetting of Processing 1 is not carried out, a marker device (a wireless access device) to serve as the reference for identifying location information is determined in order to make an inquiry to the DHCP server 8. The marker device is desirably the access point AP or base station BS (may simply be referred to as base station when there is no particular need to discriminate one from the other) of a wireless access network that allows fine location information identification and thus serves as the reference for identifying location information, instead of a wireless access network that is actually accessed. When it is the WiMAX network ANW2 that the user terminal 5 connects to, the access point AP of the wireless LAN ANW1, or a device having the highest radio wave strength (a Bluetooth base station or the like), is determined as a marker device for higher location information precision.

In the multi-wireless user terminal 5 whose configuration is detailed in FIG. 5, the MAC addresses and radio wave strengths of base stations which are respectively received by the PHY/MAC modules 51A, 51B, and 51C of the PHY/MAC module 51 are obtained by the radio wave strength monitoring management module 59 and managed in the radio wave strength monitoring table 55. The radio wave strength monitoring management module 59 determines a marker device to serve as the reference for area code identification from the radio wave strength held in the radio wave strength monitoring table 55 and from the priority set in advance in accordance with the type of wireless access network.

Processing 4: Acquisition of IP Address and Area Code by DHCP (see Processing 33 of FIG. 3) (Processing Steps 65 and 66 in FIG. 6A)

The user terminal 5 that is allowed to connect to the network then obtains an IP address associated with the base station that serves as a marker device by the DHCP. In this embodiment, RFC 2131 which defines DHCP is extended and a function is added to obtain, from the DHCP server 8, location information of the base station to which the user terminal 5 is connected.

(4-1) User Terminal Processing 1

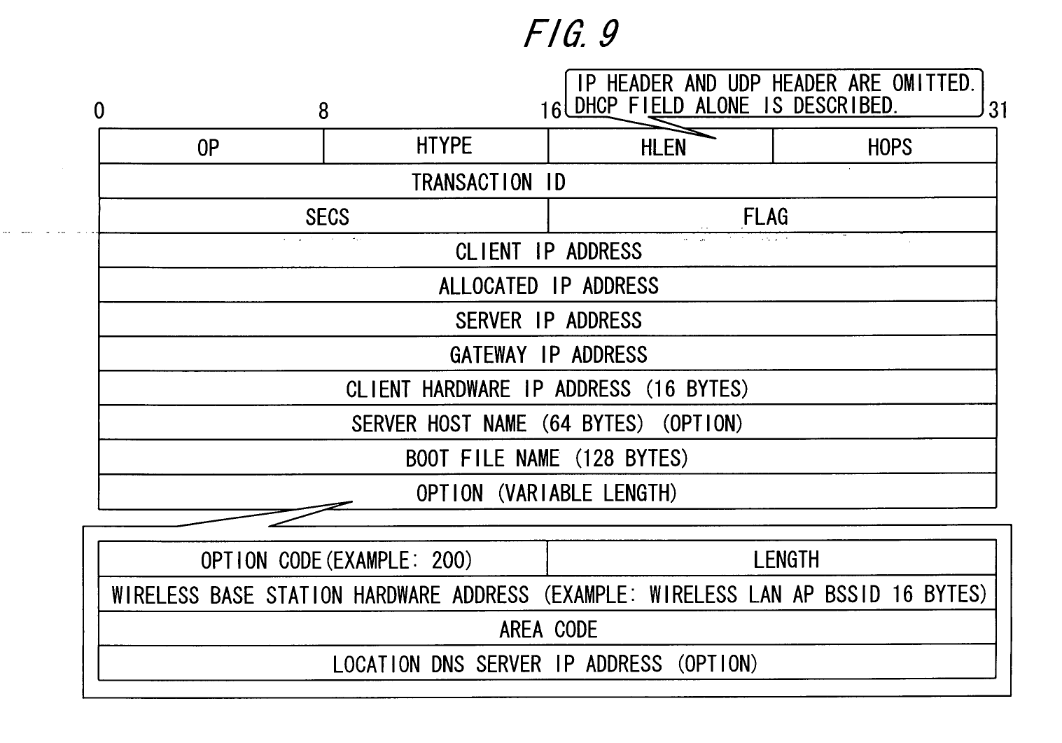

The TCP/IP normal processing module 53 of the user terminal 5 obtains the MAC address of the marker device from the radio wave strength monitoring management module 59 through the DHCP area code processing module 60, adds the obtained MAC address into an option field of a DHCP Discover message or a DHCP Request message (see FIG. 9), and sends the message to the DHCP server 8.

(4-2). DHCP Server Processing

The DHCP server 8 sends an area code in response to an inquiry from the user terminal 5. The DHCP server normal processing module 84 in the DHCP server 8 whose configuration is detailed in FIG. 8 obtains a DHCP message from the user terminal 5, extracts the MAC address of the base station from themessage's option field, and hands over the MAC address to the DHCP area code processing module 85.

The DHCP area code processing module 85 obtains an area code by referring to the conversion table 86 for conversion from a base station MAC address to an area code. The DHCP area code processing module 85 transfers the obtained area code to the DHCP normal processing module 84 to send the area code along with an IP address to the user terminal 5 in response to the inquiry. The DHCP processing module 83 manages the area code in the terminal management table 87 in association with the IP address that is assigned to the user terminal 5 (terminal IP address).

(4-3) User Terminal Processing 2

The user terminal 5 obtains an area code from the DHCP server 8 and keeps the obtained area code in the terminal settings table 56. The DHCP area code processing module 60 in the user terminal 5 obtains an area code from a DHCP message and hands over the area code to the location information management module 57, where the area code is kept.

Processing 5: DNS Server Registration Processing (see Processing 34 of FIG. 3) (Processing Step 67 in FIG. 6A)

The user terminal 5 registers mapping information of URI and IP address in the DNS server 10. The URI and the IP address need to be registered and updated through DDNS as often as suitable on the assumption that the user terminal 5 moves to new locations where the user terminal 5 use various IP addresses to access. The user terminal 5 does not directly register (update) the URI and the IP address in the DNS server 10. Instead, the URI and the IP address are temporarily registered in the local DNS server 11, and then registered in the DNS server 10 by the local DNS server 11.

(5-1) User Terminal Processing

The DNS registration/update processing module 58 in the user terminal 5 adds, to a DNS update message (see FIG. 13), mapping information where a URI obtained from the terminal settings table 56 and an IP address obtained from the TCP/IP normal processing module 53 are mapped out, and sends the message to the local DNS server 11.

(5-2) Local DNS Server Processing

In the local DNS server 11 whose configuration is detailed in FIG. 11, the DNS message analyzing module 116 analyzes a DNS update message received from the user terminal 5 to determine whether the message is about IP address registration or area code registration. When it is found as a result of the analysis that the message is about IP address registration, the normal DNS processing module 115 carries out processing of registering in the DNS server 10.

(5-3) DNS Server Processing

In the DNS server 10 whose configuration is detailed in FIG. 10, the DNS update processing module 104 of the normal DNS processing module 103 registers (updates) an IP address obtained from the local DNS server 11 in the IP address management table 107, which holds IP address-URI association.

Strictly speaking, the DNS update processing module 104 performs, through the 10/100/1000 Base-TX PHY/MAC module 101A, the OS 100 and the DNS message analyzing module 106, processing of registering an IP address received from the local DNS server 11.

Processing 6: LDNS Server Registration Processing (see Processing 35 of FIG. 3) (Processing Step 68 in FIG. 6A)

The user terminal 5 uses the obtained area code to register in the LDNS server 12. FIG. 12 shows a detailed configuration of the LDNS server 12. The DNS server 10 and the LDNS server 12 are accessed through the local DNS server 11, which is owned by a telecommunications carrier. FIG. 13 shows an example of extending a DNS update message for use in processing of registering in the LDNS server 12.

(6-1) User Terminal Processing 1

The DNS registration/update processing module 58 in the user terminal 5 adds, to a DNS update message, mapping information where a URI obtained from the terminal settings table 56 and the area code of the user terminal 5 obtained from the location information management module 57 are mapped out, and sends the message to the local DNS server 11.

(6-2) User Terminal Processing 2

The location information management module 57 of the user terminal 5 adds information on the type of a network accessed by the user terminal 5 to an area code, and registers the area code in the DNS server 10.

The location information management module 57 of the user terminal 5 obtains the type of a network that is actually accessed by the user terminal 5 from one of the wireless PHY/MAC modules 51A, 51B and 51C, and partially converts the already obtained area code.

In an area code “+83-ab-cde-0000” shown in FIG. 15 as a specific example, when the network that the user terminal 5 actually accesses is the WiMAX network ANW2, the location information management module 57 changes the identification field F4 from “0” to “2”. The rest of the processing is the same as Processing (6-1) described above.

(6-3) Local DNS Server Processing

In the local DNS server 11, the DNS message analyzing module 116 of the DNS processing module 113 analyzes a DNS update message received from the user terminal 5 to determine whether the message is about IP address registration or area code registration. When it is found as a result of the analysis that the message is about area code registration, the LDNS processing module 114 carries out processing of registering in the LDNS server 12.

Whether the received DNS update message is about IP address registration or area code registration is judged in the DNS message analyzing module 116 by referring to the “TYPE value” of the DNS update message shown in FIG. 13. When the message contains “150” as the TYPE value of the area code, for example, the DNS message analyzing module 116 determines that the message is about area code registration, and hands over the data to the LDNS processing module 114.

(6-4) LDNS Server Processing

The LDNS server 12 registers and manages an area code obtained as location information from the user terminal 5.

In the LDNS server 12 whose configuration is detailed in FIG. 12, the DNS registration module 124 of the DNS processing module 123 obtains an area code as location information by way of a DNS update message from the user terminal 5 through the 10/100 Base-TX PHY/MAC module 121A and the OS 120.

The DNS registration module 124 registers the area code of the user terminal 5 in the area code-URI registration table (NAPTR resource code) 125. Since the assumption here is that different user terminals 5 are in one area, the server is mounted such that multiple user terminals 5 can be managed in association with one area code by further managing the URI in another table, specifically, the terminal URI management table 126.

[Operation B: Procedure of Updating Terminal Location upon Switching of Marker Device]

In the communication network system SYS shown in FIG. 2, the user terminal 5 keeps location information up to date by regularly monitoring radio waves on channels of respective surrounding radios and updating information that has been registered in the LDNS server 12 when there is a change in location information. A flow chart for the procedure of updating the terminal location upon switching of marker devices is shown in FIG. 6B (Processing Steps 612 to 618).

The radio wave strength monitoring management module 59 of the user terminal 5 regularly monitors the radio wave strengths of radio waves from surrounding base stations through the wireless PHY/MAC modules 51A, 51B and 51C, and updates the radio wave strength monitoring table 55 accordingly (Processing Step 612).

The radio wave strength monitoring management module 59 consults the radio wave strength monitoring table 55 to judge whether or not the base station that is optimum for obtaining area codes (marker device) has changed (613). In the case where the current marker device is changed (in the case where the order of records of the table 55 has been rearranged), the radio wave strength monitoring management module 59 activates processing of asking the location information management module 57 for an area code (614).

As in the terminal location registration procedure of Operation A described above, the user terminal 5 makes an inquiry about the area code through the DHCP server 8, and when there is a change in area code, updates, through the local DNS server 11, information registered in the LDNS server 12 (615 to 618, see Processing 33, 34, 35 of FIG. 3).

[Operation C: Procedure of Updating Terminal Location upon Handover]

In the communication network system SYS shown in FIG. 2, when the IP address and area code of the user terminal 5 are changed during handover (roaming), the user terminal 5 updates, through the local DNS server 11, information registered in the DNS server 10 or in the LDNS server 12. A flow chart for the procedure of updating the terminal location upon handover is shown in FIG. 6C (Processing Steps 622 to 628).

When the user terminal 5 moves from one wireless zone to another in the communication network system SYS, handover or roaming processing (switching of base stations) takes place (Processing Step 622). As a result of Processing 622, the user terminal 5 is connected to a new base station near a place to which the user terminal 5 has moved (623). The handover/roaming processing is performed by the wireless PHY/MAC modules 51A, 51B and 51C and the OS 50.

Then a marker device in the area where the user terminal 5 is now located is determined (624). This operation is carried out through the same procedure as Processing 32 described in detail with reference to FIG. 3. After the handover/roaming processing, the user terminal 5 connects to the new network to which the user terminal 5 is handed over, and performs the same processing as the activation and subsequent procedures (625 to 628). For details of the operation, see Processing 33 to 35 of Operation A described above.

[Operation D: Procedure of Information Delivery from Information Transmission Terminal]

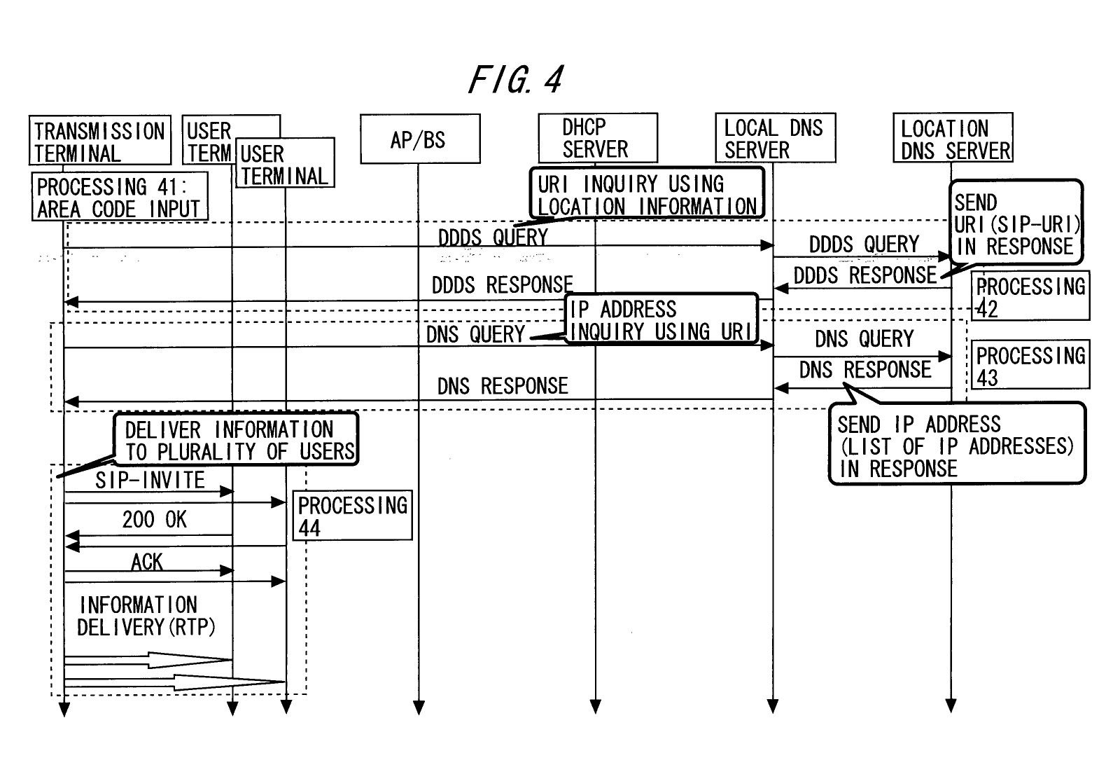

In the communication network system SYS shown in FIG. 2, when the information transmission terminal 7 contained in the enterprise network ENW transmits information (also referred to as “delivers information” or “provides information”), the sender of the information enters the area code of a target area. The information transmission terminal 7 asks the LDNS server 12 for the URIs (SIP-URI or the like) of multiple user terminals 5 in the target area. Using the obtained URIS, the information transmission terminal 7 makes an inquiry to the DNS server 10 to obtain the IP addresses of the user terminals 5, and thus delivers the information. A sequence of the procedure of delivering information from the information transmission terminal 7 is shown in FIG. 4.

Processing 1: Area Code Input (see Processing 41 of FIG. 4)

In the information transmission terminal 7 whose configuration is detailed in FIG. 7, the information sender activates the information transmission application module 78 and enters the area code of an area to which information is transmitted. The information sender in this case directly enters the area code through an input module (omitted from the drawing) of the information transmission terminal 7. Alternatively, the information sender may be aided by map software installed in the information transmission terminal 7 in advance, so the area code is automatically entered in accordance with the information sender's clicking operation on a map displayed on the screen.

The information sender activates the information transmission application module (SIP or the like) 78 of the application module 75 through a screen displayed on the information transmission terminal 7. The information transmission application module 78 activates an area code input menu through the area code control module 79 and prompts the information sender to enter an area code. The entered area code is sent from the information transmission application module 78 to the area code control module 79, which then stores the area code in the terminal settings table 77.

Processing 2: Acquisition of URI of User Terminal in Information Transmitted Area (see Processing 42 of FIG. 4)

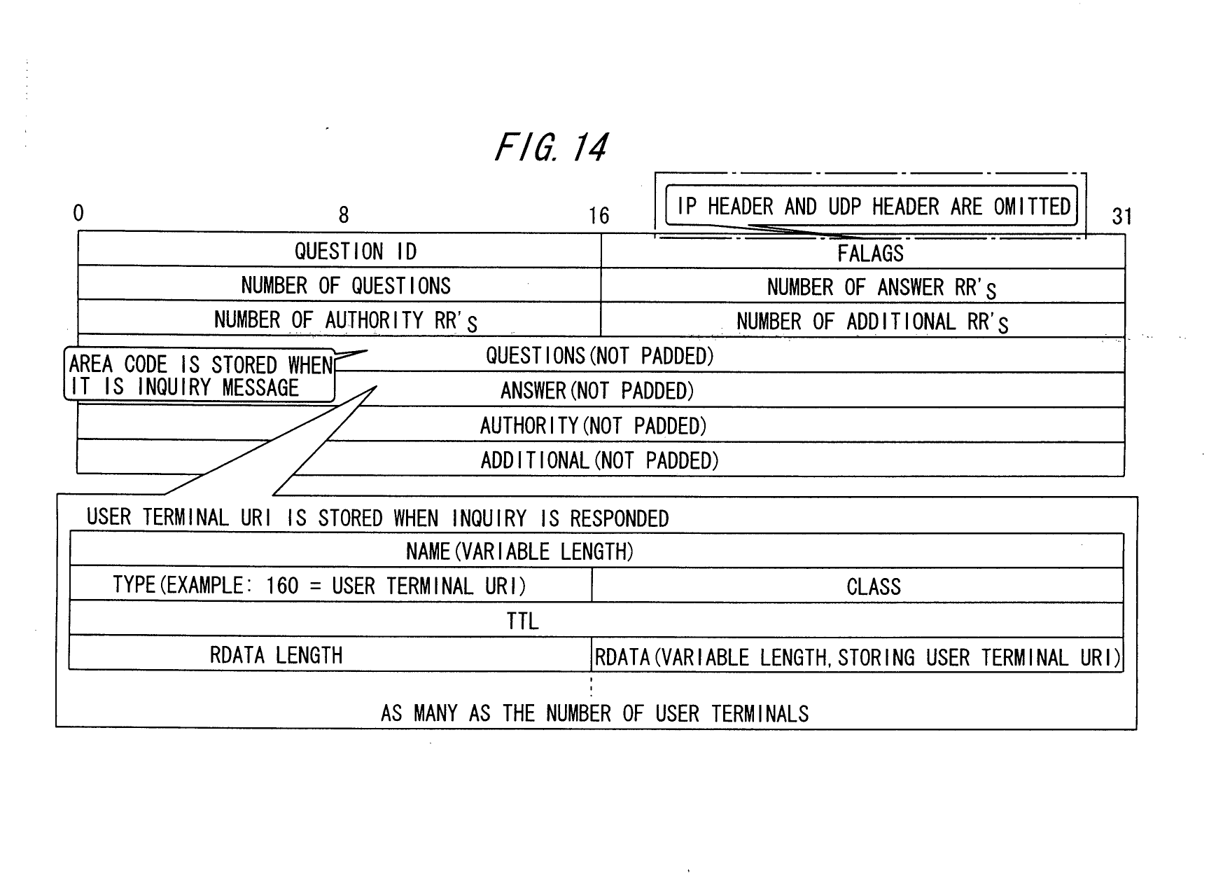

After the information sender enters an area code in the information transmission terminal 7, the DNS/DDDS procedure is employed to inquire the LDNS server 12 about the URIs of multiple user terminals 5 located in a specific area to which information is delivered. FIG. 14 shows an example of extending a DDDS message for use in processing of making an inquiry to the LDNS server 12.

(2-1) Information Transmission Terminal Processing 1

The information transmission terminal 7 creates an inquiry message from the area code entered, and sends the inquiry message to the LDNS server 12.

The area code control module 79 in the information transmission terminal 7 sends the entered area code to the DDDS/DNS message processing module 74 of the TCP/IP control module 72. The DDDS/DNS message processing module 74 notifies the local DNS server 11 of the area code through the OS 70 and the 10/100/1000 Base-TX PHY/MAC module 71A.

(2-2) Local DNS Server Processing

In the local DNS server 11, the DNS message analyzing module 116 analyzes the DNS inquiry message received from the information transmission terminal 7 to determine whether the message is an IP address inquiry or an area code inquiry. When it is found as a result of the analysis that the message is an area code inquiry, the LDNS processing module 114 carries out processing of making an inquiry to the LDNS server 12.

(2-3) LDNS Server Processing

The LDNS server 12 analyzes the inquiry message (DDDS message) received through the local DNS server 11 from the information transmission terminal 7, and sends URIs in response.

In the LDNS server 12, the DNS registration module 124 of the DNS processing module 123 obtains the location inquiry from the information transmission terminal 7 through the local DNS server 11. The DNS registration module 124 obtains an area code from the inquiry message, and refers to the area code-URI registration table 125 and another table, specifically the terminal URI management table 126, to obtain the URIs of all relevant user terminals 5. The DNS registration module 124 sends the obtained URI to the information transmission terminal 7 by way of the extended DDDS message shown in FIG. 14 in response to the inquiry message.

Processing 3: Acquisition of User Terminal (Information Receiver Terminal) IP Address (see Processing 43 of FIG. 4)

After obtaining the URIs of the user terminals 5, the information transmission terminal 7 employs the DNS procedure to ask the DNS server 10 for the IP addresses of multiple user terminals 5 to which information is delivered.

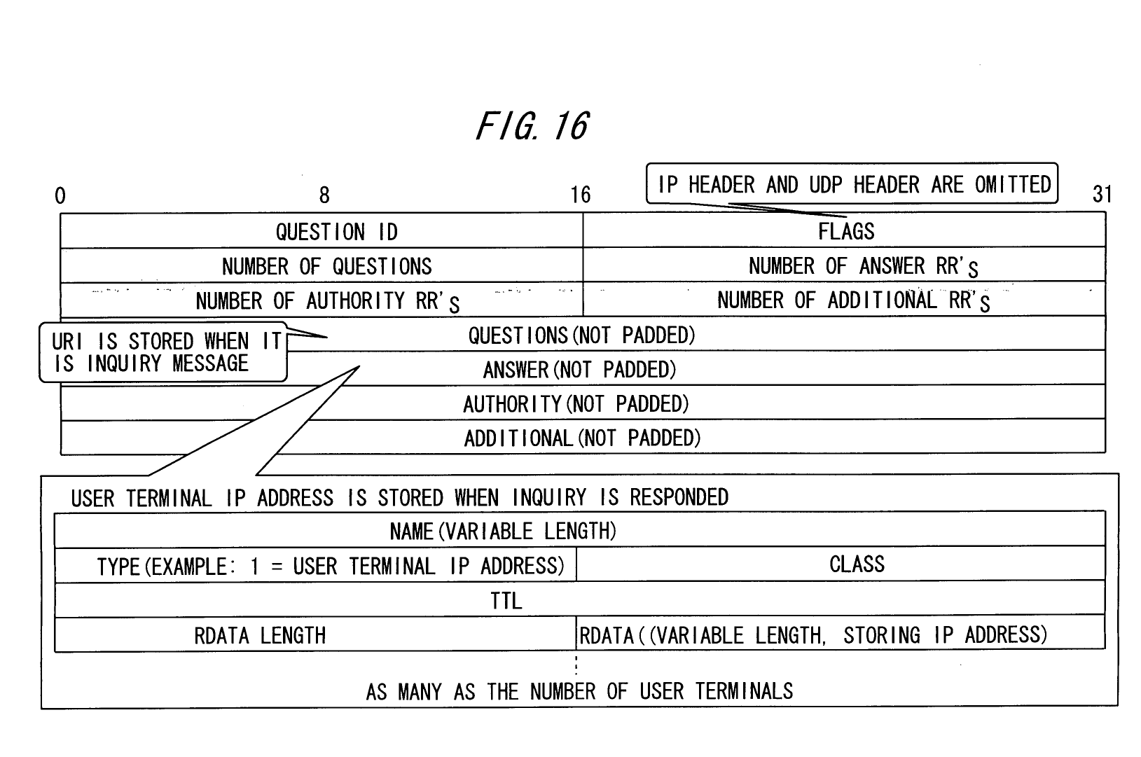

FIG. 16 shows an example of a DNS message used in the processing of making an inquiry to the DNS server 10. The IP addresses of multiple user terminals 5 may be asked for in a single DNS message or in separate DNS messages. The obtained URIs of the user terminals 5 are stored in the user information table 76 in the information transmission terminal 7.

(3-1) Information Transmission Terminal Processing 1

The information transmission terminal 7 creates an inquiry message from the URIs and sends the inquiry message to the local DNS server 11.

The information transmission application module 78 of the information transmission terminal 7 obtains the URIs from the user information table 76 and notifies the DDDS/DNS message processing module 74 of the obtained URIs, thereby sending the inquiry message to the local DNS server 11.

(3-2) Local DNS Server Processing

In the local DNS server 11, the DNS message analyzing module 116 analyzes the DNS inquiry message received from the information transmission terminal 7 to determine whether the message is an IP address inquiry or an area code inquiry. When it is found as a result of the analysis that the message is an IP address inquiry, the normal DNS processing module 115 carries out the processing of making an inquiry to the DNS server 10 through the DNS message analyzing module 116.

(3-3) DNS Server Processing

The DNS server 10 analyzes the inquiry message (DNS message) received through the local DNS server 11 from the information transmission terminal 7, and sends IP addresses in response.

In the DNS server 10, the DNS address resolution module 105 of the normal DNS processing module 103 obtains the location inquiry from the information transmission terminal 7. The DNS address resolution module 105 obtains URIs from the inquiry message, extracts from the IP address management table 107 the IP addresses of all user terminals 5 that are associated with the obtained URIs, and sends the IP addresses to the information transmission terminal 7 by way of the DNS message shown in FIG. 16 in response to the inquiry message.

(3-4) Information Transmission Terminal Processing 2

The information transmission terminal 7 stores, in the user information table 76, the IP addresses obtained from the DNS server 10 through the local DNS server 11.

Processing 4: Information Transmission to User Terminal (Information Receiver Terminal) (see Processing 44 of FIG. 4)

The information transmission terminal 7 uses the obtained IP addresses and a call control procedure such as SIP to establish calls to the respective user terminals 5, and delivers information.

The information transmission application module 78 of the information transmission terminal 7 obtains the IP addresses of the user terminal 5 from the user information table 76, and sends an SIP INVITE message to the user terminals 5. The information transmission terminal 7 exchanges such messages as “200 OK” and “ACK” with the user terminals 5, to thereby establish calls. Using RTP (Real-time Transfer Protocol) or the like, the information transmission terminal 7 then sends information to be provided to the user terminals 5.

[Operation E: Data Deletion Procedure]

In the communication network system SYS shown in FIG. 2, the LDNS server 12 uses a timer in managing area codes and other data it holds in order to prevent data from remaining indefinitely in the LDNS server 12. The LDNS server 12 deletes data it holds when the timer finishes counting. A flow chart for a data deletion procedure is shown in FIG. 6D (Processing Steps 632 to 638)

In the LDNS server 12 shown in FIG. 12, the DNS registration module 124 registers user data about the user terminal 5 (Processing Step 632), and then monitors the user data using a timer. The DNS registration module 124 monitors for a data update made by the user terminal 5 while the timer is counting. In the case where update data is received, the DNS registration module 124 refers to the area code-URI registration table 125 and the terminal URI management table 126, and updates the timer value. In the case where there is a change in area code, the DNS registration module 124 updates data in the area code-URI registration table 125 and the terminal URI management table 126 (633 to 636).

In the case where no data update is made by the user terminal 5 during timer monitoring, the DNS registration module 124 judges that the user terminal 5 has been powered off or moved out of the reception range, and deletes the data (area code) of this user terminal 5 from the area code-URI registration table 125 (637, 638).

### Effect of Embodiment

An embodiment of the present invention makes area-based information delivery utilizing IP technology possible regardless of the type of access network, and information can be delivered uniformly, by multi-cast or the like, to user terminals whose wireless access network types differ from one another if the user terminals are in the same area. The present invention is not particularly limited to wireless access networks and is also applicable to user terminals that connect to wired access networks. The present invention can therefore provide an FMC (Fixed Mobile Convergence) information delivery service where mobile communications and wired communications are blended as in the use of a mobile phone terminal as a cordless handset of a landline phone terminal.

In addition, the present invention uses DNS and DHCP, which are general IP mechanisms, to accomplish the function described above, and therefore can readily be applied to existing application software (message sending software and the like) Information is delivered only to a user who registers his/her location through DDNS, and is not delivered to a user who does not wish to receive the information delivery. Also, users can sign up to or off from the information providing service at will.

Furthermore, the present invention makes it possible to deliver information to multiple subscribers (user terminals) located in a specific area. Accordingly, a local organization (a travel agency, a local government, or a local trade association, for example) can deliver local information, tourist attraction information, and information valid for a limited time to travelers who have signed up to the service in advance only while they are staying in the area. This is advantageous to users in that information of a specified area can be received, and is advantageous to such organizations as those in tourist business in that the improved convenience in sight-seeing and shopping attracts more customers.

The information providing service control system according to an embodiment of the present invention is superior to prior art in the following aspects:

(1) Since the present invention utilizes existing DHCP and DNS, there is no need to newly mount a control module for obtaining location information, and the present invention can be applied by extending, only a little, functions that are indispensable to normal mobile IP phone terminals. The introduction of the present invention to an existing system therefore requires only a few adjustments.

(2) By employing the present DNS server-like management in management of location information, location information management can be hierarchized and the service can be provided as a public service (a universal service independent of a specific business organization).

(3) In the case where the E.164 phone number system is used as location information, the existing ENUM procedure can be utilized and accordingly the introduction of the present invention requires even fewer adjustments.

[Modification Example]

In the communication network system SYS of the embodiment described above, the DNS server 10, the local DNS server 11, and the LDNS server 12 are separate from one another, but the functions of these servers may be integrated into one DNS server.

Wireless access networks of different types may include WiFi (Wireless Fidelity) networks in addition to wireless LANs and WiMAX networks.

The processing in the embodiment described above is provided as computer-executable programs, and can be provided in the form of recoding medium such as CD-ROM or flexible disk, or through a communication line.

It is not always necessary to execute all of the processing in the embodiment described above. Instead, some of the processing may be selected to be executed in combination.

The disclosure of Japanese Patent Application No. JP2006-206887 filed on Jul. 28, 2006 including the specification, claims, drawings and abstract is incorporated herein by reference in its entirety.

What is claimed is:

1. An information providing service control system integrating access networks of different types with an IP (Internet Protocol) core network for being able to deliver information from an information transmission terminal to multiple user terminals in a specific area by using an IP address regardless of the type of the access network, comprising:
a first management module for managing location information of areas that the plurality of user terminals are located in association with multiple URIs (Uniform Resource Identifiers);
a first resolution module for sending, in response to a first inquiry, the plurality of URIs associated with the plurality of user terminals in the specific area, the first inquiry being created based on the location information of the specific area entered from the information transmission terminal;
a second management module for managing the plurality of URIs of the user terminals in association with multiple IP addresses; and
a second resolution module for sending, in response to a second inquiry from the information transmission terminal, the plurality of IP addresses associated with the plurality of user terminals in the specific area, the second inquiry being created based on the URIs sent in response.

2. An information providing service control system according to claim 1, further comprising an analyzing module for discriminating a first message or a second message and determining a transferring destination of the discriminated message, the first message being for having the first resolution module resolve the URIs based on the location information, the second message being for having the second resolution module resolve the IP addresses based on the URIs.

3. An information providing service control system according to claim 1, wherein the first management module, the first resolution module, the second management module, and the second resolution module are placed in at least one DNS (Domain Name System) server.

4. An information providing service control system according to claim 2, wherein the first management module and the first resolution module are placed in a first DNS (Domain Name System) server, the second management module and the second resolution module are placed in a second DNS server, and the analyzing module is placed in a third DNS server.

5. An information providing service control system according to claim 1, wherein the first inquiry is a DDDS (Dynamic Delegation Discovery System) query and the second inquiry is a DNS (Domain Name System) query.

6. An information providing service control system according to claim 2, wherein the first message and the second message are DNS (Domain Name System) messages.

7. An information providing service control system according to claim 1, wherein the access networks of different types include multiple types of access networks selected from a wired access network and wireless access networks, the wireless access network including a wireless LAN (Local Area Network), a mobile phone network, and a WiMAX (Worldwide Interoperability for Microwave Access) network.

8. An information providing service control system according to claim 7, wherein the access networks of different types further include wired access networks.

9. An information providing service control system according to claim 1, wherein the location information of the areas that the plurality of user terminals are located and the location information of the specific area entered from the information transmission terminal are mapped on to an E.164 phone number system, and the first resolution module resolves the URIs through an ENUM procedure.

10. An information providing service control system according to claim 1, wherein the location information of the areas and the location information of the specific area contain identifiers for identifying the areas and the specific area, and identifiers for identifying the types of the access networks.

11. An information providing service control system according to claim 4, further comprising a DHCP (Dynamic Host Configuration Protocol) server which has a conversion table for conversion between a physical address of a base station of a wireless access network or a physical address of a default gateway of a wired access network, serving as the access network, and location information of the base station or the default gateway,
wherein the DHCP server sends, along with an allocated IP address, the location information of the base station of the wireless access network to be accessed or the location information of the default gateway of the wired access network, as the location information of the area that the user terminal is located, in response to an inquiry that is made by the user terminal when the user terminal receives radio waves from the base station or an ARP (Address Resolution Protocol) response from the default gateway and that contains an obtained physical address of the base station of the wireless access network or of the default gateway.

12. An information providing service control system according to claim 4, further comprising a DHCP (Dynamic Host Configuration Protocol) server which has a conversion table for conversion between a physical address of a base station of a wireless access network serving as the access network and location information of the base station,
wherein, when the user terminal is handed over from one base station of the wireless access network to another base station and makes an inquiry created from a physical address of the base station to which the user terminal is handed over, the DHCP server sends, in response to the inquiry, along with an allocated IP address, the location information of the base station as the location information of the area that the user terminal is located, and enables the user terminal to send and register the location information to the first DNS server.

13. An information providing service control system according to claim 4, further comprising a DHCP (Dynamic Host Configuration Protocol) server which has a conversion table for conversion between a physical address of a base station of a wireless access network serving as the access network and location information of the base station,
wherein, when the user terminal is capable of accessing different types of the wireless access networks and chooses the physical address of the base station of the wireless access network that covers a narrower area and allows fine location identification, rather than the wireless access network with which the user terminal actually communicates, or when the user terminal makes an inquiry created from the obtained plurality of physical addresses, the DHCP server sends, in response to the inquiry, the location information of the base station as the location information of the area that the user terminal is located, and enables the user terminal to send and register the location information to the first DNS server.

14. An information providing service control system according to claim 4, further comprising a DHCP (Dynamic Host Configuration Protocol) server which has a conversion table for conversion between a physical address of a base station of a wireless access network serving as the access network and location information of the base station,
wherein the user terminal monitors a radio wave strength of a wireless access network that covers a narrower area, rather than a wireless access network with which the user terminal actually communicates, and when the radio wave strength of a base station that has had the highest radio wave strength becomes weaker than that of another base station and the user terminal makes an inquiry created from the physical address of the base station that now has the highest radio wave strength, the DHCP server sends, in response to the inquiry, the location information of the base station of the highest radio wave strength as the location information of the area that the user terminal is located, and enables the user terminal to send and register the location information to the first DNS server.

15. An information providing service control system according to claim 4, further comprising a DHCP (Dynamic Host Configuration Protocol) server which has a conversion table for conversion between a physical address of a base station of a wireless access network serving as the access network and location information of the base station,
wherein, when the user terminal moves from one location to another location causing the IP address to change, the DHCP server requests the first DNS server to update the location information of the area that the user terminal is located, and makes automatic IP address update possible through a DDNS (Dynamic Domain Name System) function.

16. An information providing service control system according to claim 1, wherein the first management module dynamically updates data to be managed by setting a timer for each piece of entry data and deleting entry data that has expired.

17. An information providing service control method integrating access networks of different types with an IP (Internet Protocol) core network for being able to deliver information from an information transmission terminal to multiple user terminals in a specific area by using an IP address regardless of the type of the access network, comprising:
managing location information of areas that the plurality of user terminals are located in association with multiple URIs (Uniform Resource Identifiers);
sending, in response to a first inquiry, the plurality of URIs associated with the plurality of user terminals in the specific area, the first inquiry being created based on the location information of the specific area entered from the information transmission terminal;
managing the plurality of URIs of the plurality of user terminals in association with multiple IP addresses; and
sending, in response to a second inquiry from the information transmission terminal, the plurality of IP addresses associated with the plurality of user terminals in the specific area, the second inquiry being created based on the URIs sent in response.

18. An information providing service control method according to claim 17, further comprising: discriminating a first message or a second message and determining a transferring destination of the discriminated message, the first message being for resolution of the URIs based on the location information of the area that the user terminals are located, the second message being for resolution of the IP addresses based on the URIS.
